(19) United States
(12) Patent Application Publication
(10) Pub. No.: US 2022/0408765 A1
(43) Pub. Date: Dec. 29, 2022

(54) WHEAT BRAN COMPOSITION AND METHOD FOR PRODUCING SAME

(71) Applicants: NISSHIN FLOUR MILLING INC., Tokyo (JP); Nisshin Seifun Welna Inc., Tokyo (JP); Nisshin Seifun Group Inc., Tokyo (JP)

(72) Inventors: Koji MURAKAMI, Tokyo (JP); Katsutoshi OZAKI, Tokyo (JP); Koji ISHIZUKA, Tokyo (JP); Hitomi NISHITSUJI, Tokyo (JP); Satomi NOZAKI, Fujimino-shi (JP)

(73) Assignees: NISSHIN FLOUR MILLING INC., Tokyo (JP); Nisshin Seifun Welna Inc., Tokyo (JP); Nisshin Seifun Group Inc., Tokyo (JP)

(21) Appl. No.: 17/762,121

(22) PCT Filed: Sep. 29, 2020
(86) PCT No.: PCT/JP2020/036811

§ 371 Date: Mar. 21, 2022

(30) Foreign Application Priority Data
Sep. 30, 2019 (JP) 2019-180401

(51) Int. Cl. A23L 7/10; A23L 5/10

(52) U.S. Cl. CPC A23L 7/115; A23L 5/10; A23V 2002/00

(57) ABSTRACT

A wheat bran composition of the invention contains a white wheat as a raw material, wherein the wheat bran composition has a dietary fiber content of 43 mass % or greater and a glucide content of 18 mass % or less. The invention also provides a method for producing a wheat bran composition, involving pulverizing grains of a white wheat to obtain a wheat bran composition having a dietary fiber content of 43 mass % or greater and a glucide content of 18 mass % or less. The invention also provides a premix containing the wheat bran composition. The invention also provides a method for producing a processed food involving using the wheat bran composition as a raw material.

### TECHNICAL FIELD

The present invention relates to a wheat bran composition and a method for producing the same.

### BACKGROUND ART

The rise in health consciousness in recent years has led to the production of secondary processed products, such as bread, noodles, etc., using wheat bran which is rich in various nutrients such as dietary fiber, vitamins, minerals, etc., as well as functional components, and has a favorable flavor. Applicant has previously proposed methods for efficiently producing wheat bran having excellent secondary processability and offering favorable appearance, flavor and texture in secondary processed products (see Patent Literatures 1 and 2).

Patent Literature 3 discloses a wheat flour composition for bread with the aim of producing palatable bread with excellent characteristics such as flavor, texture, appearance, etc. The wheat flour composition is a mixture containing from 4 to 25 parts by mass of wheat bran derived from white wheat with respect to 100 parts by mass of wheat flour derived from red wheat. Patent Literature 4 discloses a method for producing finely pulverized bran with the aim of reducing bran odor. The method uses Western White as wheat, and involves: collecting bran in a medium particle-size fraction from among fractions of bran, which is separated during a milling step for obtaining wheat flour from the wheat, by excluding fractions having smaller particle sizes than a predetermined value and fractions having larger particle sizes than a predetermined value; roasting the collected bran; and then pulverizing the same so that the median diameter in particle size distribution becomes 100 μm or less.

### CITATION LIST

### Patent Literature

Patent Literature 1: JP 2013-243984A

Patent Literature 2: JP 2015-53868A

Patent Literature 3: JP 2009-254240A

Patent Literature 4: JP 2017-12099A

### SUMMARY OF INVENTION

The production methods of Patent Literatures 1 and 2 are capable of efficiently producing wheat bran having excellent secondary processability and offering favorable appearance, flavor and texture in secondary processed products. These methods, however, still have room for improvement, particularly in terms of further enhancement of secondary processability. Meanwhile, the techniques of Patent Literatures 3 and 4 can only obtain wheat bran with poor secondary processability, and the texture etc. of secondary processed products obtained therefrom is far from satisfactory.

An objective of the present invention is to provide a wheat bran composition that has excellent secondary processing suitability and that can be processed into secondary processed products having excellent appearance, flavor and texture, and also a method for producing the wheat bran composition.

The present invention provides a wheat bran composition containing a white wheat as a raw material, wherein the wheat bran composition has a dietary fiber content of 43 mass % or greater and a glucide content of 18 mass % or less.

The present invention also provides a method for producing a wheat bran composition, the method involving pulverizing grains of a white wheat to obtain a wheat bran composition having a dietary fiber content of 43 mass % or greater and a glucide content of 18 mass % or less.

### Description of Embodiments

The wheat bran composition and production method therefor according to the present invention will be described below according to preferred embodiments thereof. In the following description, the expression “X-Y [Z]” (X and Y represent arbitrary numbers; [Z] represents an arbitrary unit) means “from X [Z] to Y [Z]” unless specifically stated otherwise.

A wheat bran composition of the present invention contains wheat bran obtained using, as a raw material, a white wheat which is a species of Triticum in the family Poaceae, and containing predetermined amounts of dietary fiber and glucide. In general, a wheat caryopsis (a wheat grain) can be roughly divided into the endosperm, the outer layers (pericarp and testa) and germ (embryo). Wheat bran is the fraction originating from the outer layers obtained by pulverizing the wheat grains and removing the endosperm and germ. Typically, a pulverized product of wheat bran produced in this manner has a moisture content of 15 mass % or less. The present wheat bran composition encompasses both the aforementioned fraction used as-is, and processed products of wheat bran obtained by further subjecting the fraction to pulverization, classification, heat treatment, etc. This wheat bran composition typically has a moisture content of 3-15 mass %, and is preferably a powder-like matter. In the following description, for the sake of explanation, powder-like wheat bran compositions having a moisture content within the aforementioned range are described as examples, unless specifically stated otherwise. It is preferable that the contents of respective components are as described below in cases where the moisture content of the wheat bran composition is 8-9 mass %, from the viewpoint of obtaining a composition with high quality.

Wheat can be roughly classified into two types, red wheat and white wheat, depending on the color when the wheat grains are visually observed. Red wheat contains a red pigment in its outer layer; thus, red wheat exhibits a red, reddish-brown, or brown color when the wheat grains are visually observed. In contrast, white wheat contains substantially no red pigment in its outer layer; thus, white wheat exhibits a white or pale-yellow color when the wheat grains are visually observed. The present invention employs white wheat as a raw material of the wheat bran composition. In this way, secondary processing suitability can be improved. Also, secondary processed products obtained therefrom will not only have a favorable flavor in which unpleasant taste, such as bitterness and acridness, originating from wheat bran is reduced, but will also have a smooth texture and excellent appearance.

Concrete examples of white wheat usable in the present invention may include Australian Standard White (ASW; produced in Australia), Prime Hard (PH; produced in Australia), Soft White (SW; produced in the U.S.A.), and Western White (WW; produced in the U.S.A.) for common wheat, and also durum wheat (produced in various countries globally). The types of white wheat can be screened as appropriate by genetic characteristics, for example.

Common wheat can be roughly classified into three types depending on the hardness of the wheat grains, i.e., hard wheat, soft wheat, and medium-hard wheat having a hardness between hard and soft. Among these types, from the viewpoint of further improving the flavor and texture of the obtained wheat bran composition, it is preferable to use, among white wheat, white wheat classified as medium-hard wheat. Among the examples of white wheat and common wheat described above, an example of hard wheat may include Prime Hard etc., an example of medium-hard wheat may include Australian Standard White etc., and a concrete example of soft wheat may include Western White etc. That is, for example, ASW can suitably be used as white wheat classified as medium-hard wheat.

In the wheat bran composition of the present invention, the content of dietary fiber with respect to the mass of the composition may preferably be 43 mass % or greater, more preferably 44 mass % or greater, even more preferably 45 mass % or greater, and is realistically 60 mass % or less from the viewpoint of the efficiency of producing secondary processed products. By setting the dietary fiber content within this range, secondary processed products produced using the wheat bran composition will have excellent flavor and texture originating from wheat bran and will also have a favorable appearance. Also, health-promoting effects owing to the intake of dietary fiber can be achieved. The dietary fiber content can be appropriately adjusted, for example, by subjecting the wheat bran fraction, which is obtained by pulverizing wheat grains, to further treatment such as pulverization and/or classification, to increase the content of the outer layers of wheat.

In the present invention, “dietary fiber content” is a value quantified by the modified Prosky method (an analysis method based on AOAC Method 985.29) according to the Analytical Manual of the Standard Tables of Food Composition in Japan (2015; seventh revised edition) as a total amount of water-soluble dietary fiber and insoluble dietary fiber. The dietary fiber content can be measured, for example, using a commercially available measurement kit based on the modified Prosky method.

In the wheat bran composition of the present invention, the content of glucide with respect to the mass of the composition may preferably be 18 mass % or less, more preferably 17.7 mass % or less, even more preferably 17 mass % or less, even more preferably 16 mass % or less, and is realistically 10 mass % or greater from the viewpoint of the efficiency of producing secondary processed products. By setting the glucide content within this range, it is possible to improve the suitability of the wheat bran composition to secondary processing, thus providing the obtained secondary processed products with excellent appearance and texture. The glucide content can be appropriately adjusted, for example, by subjecting the wheat bran fraction, which is obtained by pulverizing wheat grains, to further treatment such as pulverization and/or classification.

In the present invention, “glucide content” may be a value found, for example, by subtracting the amount of dietary fiber from the amount of carbohydrate found by the subtractive method according to the Analytical Manual of the Standard Tables of Food Composition in Japan (2015; seventh revised edition). More specifically, in the present invention, the glucide content is a value found by subtracting the respective masses of moisture, proteins, lipids, ash content, and dietary fiber from 100 g of an object being measured. The respective masses of moisture, proteins, lipids, ash content, and dietary fiber can be quantified according to the aforementioned Analytical Manual.

The wheat bran composition having the aforementioned constitution has high secondary processing suitability and can improve various physical properties, such as resilience, shape retainability, shapeability, etc., of doughs/batters produced by using the wheat bran composition at the time of secondary processing of food products such as bread, noodles, etc. Further, secondary processed products processed using the wheat bran composition are reduced in unpleasant taste, such as bitterness and acridness, originating from wheat bran, and thus have excellent flavor and texture and favorable appearance. This is described in detail. Starch is contained in the wheat's outer layers and peripheral portions thereof, which are materials of wheat bran. Starch, however, seldom has a structure suitable for secondary processing, and also, the starch often has poor quality. Using a wheat bran composition containing such starch for secondary processing tends to impair various physical properties of doughs/batters, which may result in deterioration of texture and appearance of secondary processed products. In this regard, the wheat bran composition of the present invention has a low glucide content, which suppresses poor-quality starch from getting admixed, thus resulting in an improvement in secondary processing suitability and enhancement in appearance and texture of secondary processed products. In addition, the wheat bran composition uses white wheat as its material, and this enables secondary processed products to exhibit favorable flavor with reduced bitterness, acridness, etc., compared to cases of using red wheat. Furthermore, the inclusion of a predetermined amount of dietary fiber not only improves secondary processing suitability, appearance, flavor and texture, but can also efficiently achieve health-promoting effects owing to the intake of dietary fiber.

From the viewpoint of further emphasizing the smooth favorable texture of secondary processed products that are obtained when producing these secondary processed products by using the wheat bran composition, it is preferable that the wheat bran composition has an average particle size of preferably 10-200 μm, more preferably 20-150 μm, even preferably 30-120 μm, even more preferably 50-100 μm. In the present invention, “average particle size” refers to volume cumulative particle diameter D50 at a cumulative volume of 50 vol %, as measured in a dry mode with a laser diffraction/scattering particle size distribution measurement device (e.g., Microtrac particle size distribution measurement device 9200FRA from Nikkiso Co., Ltd.).

From the viewpoint of further improving the appearance of the wheat bran composition and secondary processed products using the same, the L value of the wheat bran composition may preferably be from 60 to 100. The L value refers to the L* value defined by the CIE 1976 (L*, a*, b*) color space (CIELAB), and can be measured, for example, according to JIS Z8781.

In the wheat bran composition, the content of arabinoxylan with respect to the mass of the composition may preferably be 20 mass % or greater, more preferably 20-25 mass %. Arabinoxylan is a type of water-soluble dietary fiber obtained by polymerizing arabinose and xylose, and is reported as having immuno-enhancement actions etc. Thus, health-promoting effects can be further improved by the intake of the wheat bran composition containing the aforementioned amount of arabinoxylan, as well as secondary processed products produced using the wheat bran composition. The arabinoxylan content can be measured, for example, by quantification using high-performance liquid chromatography under the following measurement conditions, although not limited to this method. A pre-treatment for this method is as follows: 0.6 g of a wheat bran composition to be measured is mixed in a 72 v/v% sulfuric acid aqueous solution and stirred at room temperature for 1 hour, and then, the solid content obtained by stirring is mixed in a 4 v/v% sulfuric acid aqueous solution and subjected to an autoclave treatment (at 121° C. for 20 minutes). The aqueous solution is then cooled and neutralized, and the volume thereof is adjusted to 200 mL. This solution is then filtered, and the obtained filtrate is introduced to high-performance liquid chromatography, to quantify the respective amounts of arabinose, xylose and galactose. The quantitative values obtained respectively for arabinose, xylose and galactose are substituted into the following calculation equation, to calculate the mass (g) of arabinoxylan. The arabinoxylan content (mass %) is the percentage of the mass (g) of arabinoxylan with respect to the mass (g) of the wheat bran composition being measured.

Mass (g) of arabinoxylan=0.88×(Mass (g) of arabinose+Mass (g) of xylose−0.7×Mass (g) of galactose)

Example of Measurement Conditions for High-Performance Liquid Chromatography:

Model: LC-20AD (Shimadzu Corporation)

Detector: Fluorescence spectrophotometer RF-20Axs (Shimadzu Corporation)

Column: TSK gel SUGAR AXI; φ4.6 mm×150 mm (Tosoh Corporation)

Column temperature: 60° C.

Mobile phase: 0.5 mol/L boric acid buffer (pH 8.7)

Flow rate: 0.4 mL/min

Injection amount: 20 μL

Fluorescence excitation wavelength: 320 nm

Fluorescence measurement wavelength: 430 mm

Post-column: Reaction solution: 1 w/v % L-arginine solution

Reaction solution flow rate: 0.7 mL/min

Reaction temperature: 150° C.

In the wheat bran composition, the total alkylresorcinol content with respect to the mass of the composition may preferably be 0.25 mass % or greater, more preferably 0.25-1.0 mass %, even more preferably 0.25-0.52 mass %. Alkylresorcinol is a collective term for compounds having a 1,3-dihydroxy-5-n-alkylbenzene skeleton, as disclosed, for example, in JP 2016-153387A and JP 2019-104755A, and is reported as having sleep improvement action and anti-obesity action. Thus, health-promoting effects can be further improved by the intake of the wheat bran composition containing the aforementioned amount of alkylresorcinol, as well as secondary processed products produced using the wheat bran composition. Among the outer layers of wheat, alkylresorcinol is localized particularly in sections close to the aleurone layer. Particularly, the wheat bran composition of the present invention richly contains these sections and can thus richly contain the aforementioned amount of alkylresorcinol, thereby being able to further improve the health-promoting effects. In addition, a better effect of improving flavor and texture can be obtained compared to normal wheat bran. The alkylresorcinol content can be measured, for example, with partition chromatography according to the method disclosed in JP 2016-132641A.

It is preferable that the wheat bran composition is subjected to a heat treatment such as dry-heat treatment, wet-heat treatment, etc., and more preferably wet-heat treatment. Application of such heat treatment can further improve secondary processability, and the flavor and texture of secondary processed products obtained therefrom become even more favorable.

A preferable method for producing the wheat bran composition of the present invention is described below. First, grains of a white wheat, serving as a raw material, are pulverized and the endosperm and germ are separated, to obtain wheat bran (pulverization step). The white wheat grains used for the pulverization may be tempered by adding water to the grains, or may be pulverized without being tempered by addition of water. The method for collecting wheat bran from the pulverized grain product is not particularly limited, and for example, it is possible to employ a method wherein wheat bran is collected by separating the pulverized grain product into wheat bran and other components through a known classification method such as sifting etc.

For the pulverization of the white wheat grains, any pulverization method ordinarily used in the present technical field may be employed, and examples that may be used include methods such as roll pulverization, impact pulverization, airflow pulverization, etc. Grain pulverization may be performed only once, or may be performed a plurality of times with the same pulverization method or different pulverization methods. For example, roll pulverization and impact pulverization may be used in combination and performed in this order. Alternatively, roll pulverization may be performed a plurality of times in multiple stages. The types of pulverizers used for impact pulverization are not particularly limited, so long as pulverization is performed by mechanical impact between an impact plate and a rotating rotor. From the viewpoint of achieving and improving both grain pulverization efficiency and bran separation efficiency, it is preferable to employ roll pulverization.

The wheat bran of white wheat obtained as above may be used as-is as the wheat bran composition of the present invention, or may be further subjected to at least one of the steps described below before being used as the wheat bran composition of the present invention. In either case, the obtained wheat bran composition has a dietary fiber content of preferably 43 mass % or greater and a glucide content of preferably 18 mass % or less. Such a wheat bran composition can be obtained by appropriately adjusting various pulverization conditions for roll pulverization, impact pulverization, etc., and various other conditions such as conditions for classification and heat treatment which are performed as necessary. From the viewpoint of efficiently obtaining the wheat bran composition having the aforementioned dietary fiber content and glucide content, it is preferable to subject the wheat bran, obtained by the aforementioned method, to a heat treatment. By undergoing the heat treatment step, the wheat bran can be pulverized finely, which is advantageous in terms that a wheat bran composition with small particle diameters can be obtained with high productivity. Further, by undergoing the heat treatment step, the activity of various enzymes, such as amylase, protease, etc., can be reduced or quenched, which is particularly advantageous in terms that secondary processability can be further improved and also the texture of secondary processed products can be further improved.

In cases of performing dry-heat treatment as the heat treatment, the treatment may be performed for preferably 1-120 minutes, more preferably 3-50 minutes, such that the product temperature of the wheat bran is preferably 80-200° C., more preferably 90-150° C. The dry-heat treatment may be performed, for example, by introducing the wheat bran to a device having the same configuration as the heat-treatment agitation device disclosed in JP 2004-9022A, and subjecting the wheat bran to the treatment at the aforementioned temperature for the aforementioned time. This heat-treatment agitation device includes: a cylindrical container for containing an object being treated; a rotary shaft having a hollow structure and provided inside the container; hollow pipe screws formed in communication with the shaft; and a steam supply source for supplying steam through the rotary shaft and the pipe screws. The device is configured such that heat generated by supplying steam through the rotary shaft and the pipe screws can be transferred to the object being treated via the rotary shaft and the pipe screws, so that dry-heat treatment can be performed.

In cases of performing wet-heat treatment as the heat treatment, the treatment may be performed for preferably 1-60 seconds, more preferably 3-30 seconds, in a hermetically-sealed container into which water vapor is introduced, such that the product temperature of the wheat bran is preferably 80-110° C., more preferably 85-95° C. The wet-heat treatment may be performed, for example, by introducing the wheat bran, as the object being treated, together with saturated water vapor into a particulate heating device disclosed in Japanese Patent No. 2784505, and subjecting the wheat bran to the treatment at the aforementioned temperature for the aforementioned time. This particulate heating device includes: a cylindrical pressurizing container for containing an object being treated, the container having a blow-in opening for saturated water vapor; and an agitation means having a rotary shaft and a plurality of rod-shaped blades provided thereon and each having a dimension close to the inner diameter of the cylinder, the agitation means transporting particulates introduced from an introduction opening provided at one end of the container toward a discharge opening provided at the other end of the container while agitating the particulates. Particularly, performing wet-heat treatment can further improve secondary processability, and the flavor and texture of secondary processed products obtained therefrom become even more favorable.

From the viewpoint of efficiently obtaining fine particles of the wheat bran composition, it is preferable to further subject the wheat bran to fine pulverization to obtain a finely pulverized product, and it is more preferable to subject the wheat bran having undergone the aforementioned heat treatment to fine pulverization to obtain a finely pulverized product. It may also be preferable to perform this fine pulverization step through impact pulverization. It is preferable to perform the fine pulverization treatment such that the percentage of a fraction having an average particle size of less than 200 p.m is around 50-100 mass %, more preferably 70-100 mass %, with respect to the total mass of the wheat bran.

From the viewpoint of achieving a sharp particle size distribution and efficiently obtaining a wheat bran composition that can be processed into a secondary processed product having a smooth texture with little graininess, it is preferable to classify the finely pulverized product of the wheat bran and separate a fraction having an average particle size of preferably 200 p.m or less, more preferably 150 p.m or less. This classification step can be performed with a sieve or a pneumatic classification device or both.

In cases of performing this step with a sieve, it is preferable to use a sieve having an opening of preferably 150-200 μm, more preferably 150-180 μm, even more preferably 150 μm, and collect the fraction that passed through the sieve. In cases of performing this step with a pneumatic classification device, it is preferable to use a classification device capable of precisely separating a fraction bordering at a particle size of 150-200 μm, and collect a fraction having an average particle size of preferably 200 μm or less, more preferably 150 μm or less. From the viewpoint of space-saving, it is preferable to perform pulverization and classification with an impact pulverizer with a built-in pneumatic classification device. An example of an impact pulverizer with a built-in pneumatic classification device may include ACM Pulverizer (product name) from Hosokawa Micron.

The wheat bran composition of the present invention can be obtained through the aforementioned steps. Particularly, according to a preferred embodiment of the present production method, a wheat bran composition can be obtained by: pulverizing grains of a white wheat to obtain wheat bran; subjecting the wheat bran to a heat treatment; and further, finely pulverizing the wheat bran having undergone the heat treatment. In addition, it is also preferable to further classify the finely pulverized wheat bran.

The wheat bran composition can be made into a wheat bran composition-containing premix by mixing, to the wheat bran composition, one or more types of ingredients such as: cereal flour other than wheat bran, such as wheat flour, wheat germ, etc.; proteins such as gluten, etc.; starch such as unprocessed starch, processed starch (e.g., acetylated starch, etherified starch, cross-linked starch, oxidized starch), etc.; sugars such as table sugar, oligosaccharide, etc.; oils/fats such as shortening, butter, margarine, etc.; fermentation bacteria such as yeast, lactic acid bacteria, etc.; and other ingredients such as table salt, skimmed milk powder, thickeners, emulsifiers, leavening agents, etc. The premix is preferably powdery. The contents of the respective ingredients in the premix can be appropriately adjusted depending on the target processed food, which is the secondary processed product to be obtained. The content of the wheat bran composition with respect to the total mass of the premix may preferably be 1-70 mass %, more preferably 1-60 mass %.

The wheat bran composition can also be used as an ingredient to produce processed food, which is a secondary processed product. More specifically, liquid for preparing a dough/batter, such as water, cow milk, whole egg, egg white, egg yolk, fresh cream, kansui (alkaline solution), etc., may be added to and mixed with the wheat bran composition, preferably the wheat bran-containing premix, to prepare a clay-like mixture (i.e., dough) or a paste-like mixture (i.e., batter). Then, the dough/batter is shaped into the form of the intended processed food, and is dried, cooled or fermented as necessary, or subjected to a heating treatment such as baking, steam-cooking, deep-frying, boil-cooking, etc., to produce the processed food.

In cases where a wheat bran composition-containing premix is used for producing the processed food and water is used as the liquid for dough/batter preparation, the amount of liquid for dough/batter preparation to be added to the premix may preferably be around 50-100 parts by mass with respect to 100 parts by mass of the premix in cases where the mixture to be prepared is a dough, and may preferably be around 90-300 parts by mass with respect to 100 parts by mass of the premix in cases where the mixture to be prepared is a batter.

A premix containing the wheat bran composition has excellent dough/batter shapeability and excellent secondary processing suitability, and can thus be suitably used for producing various types of processed foods, with examples including: bread such as bread loafs, rolls, etc.; baked foods such as waffles, crepes, pancakes, hotcakes, sponge cake, okonomi-yaki (Japanese-style pancakes), tako-yaki (Japanese-style octopus dumplings), ohban-yaki (Japanese-style round muffins containing bean jam), tai-yaki (Japanese-style fish-shaped muffins containing bean jam), etc.; noodles such as udon (thick wheat noodles), somen and hiyamugi (thin wheat noodles), buckwheat noodles, Chinese noodles, pastas, etc.; noodle wrappers such as jiaozi wrappers, spring roll wrappers, etc.; and deep-fried foods such as tempura (Japanese deep-fried food), kara-age (unbattered deep-fried food), deep-fried marinated food, fritters, etc. The obtained processed food will have excellent appearance, flavor and texture. More specifically, in cases where the processed food is bread, the bread will have excellent appearance, favorable flavor with little bitterness or acridness, and a soft favorable texture. In cases where the processed food is noodles, the noodles will have a white, excellent appearance, favorable flavor with little bitterness or acridness, and a favorable texture with high resilience and chewiness.

### EXAMPLES

The present invention is described in further detail below by way of examples, but the present invention is not limited to the following examples. In the wheat bran compositions of the examples and comparative examples, the respective contents (mass %) of dietary fiber, glucide, arabinoxylan, and alkylresorcinol with respect to the mass of the composition were measured according to the methods described above. The results are shown in Table 1 below. The wheat bran compositions of Examples 1 to 11 and Comparative Examples 1 to 10 were all powder-like matter made from wheat bran only, wherein each composition's moisture content was adjusted within a range of 8-9 mass %, and each composition's average particle size measured according to the aforementioned measurement method was within a range of 85-94 μm.

### Examples 1 to 4 and Comparative Example 1

For the material wheat, ASW, which is a white medium-hard wheat, was used, and the wheat was cleaned and pulverized with a roll pulverizer. The pulverized product was classified with a sieve having an opening of 200 μm, and wheat bran, as the residue on the sieve, was collected.

Next, the collected wheat bran was subjected to impact pulverization with a Turbo-Mill (from Tokyo Seifunki Mfg., Co., Ltd.). Then, this pulverized product was subjected to a wet-heat treatment with a particulate heating device disclosed in Japanese Patent No. 2784505 at a product temperature of 90° C. for 5 seconds while introducing saturated water vapor. Next, the pulverized product subjected to the wet-heat treatment was finely pulverized with an impact-type fine pulverizer (ACM Pulverizer from Hosokawa Micron). Then, the finely pulverized product was classified with a sieve having an opening of 150 μm, and the fraction having passed through the sieve and having a particle size of less than 150 μm was fractionated, to obtain the target wheat bran composition. Fractions with different contents of dietary fiber and glucide were obtained by appropriately adjusting the pulverization conditions for the roll pulverization and the impact pulverization.

### EXAMPLE 5

A wheat bran composition was obtained according to the same method as in Example 1, except that, instead of the wet-heat treatment, a dry-heat treatment was performed with a device having the same configuration as the heat-treatment agitation device disclosed in JP 2004-9022A at a product temperature of 120° C. for 25 minutes.

### Examples 6 and 7 and Comparative Example 2

A wheat bran composition was obtained by performing a wet-heat treatment as in Example 1, except that WW, which is a white soft wheat, was used for the material wheat.

### Example 8

A wheat bran composition was obtained by performing a dry-heat treatment as in Example 5, except that WW, which is a white soft wheat, was used for the material wheat.

### Examples 9 and 10 and Comparative Example 3

A wheat bran composition was obtained by performing a wet-heat treatment as in Example 1, except that PH, which is a white hard wheat, was used for the material wheat.

### Example 11

A wheat bran composition was obtained by performing a dry-heat treatment as in Example 5, except that PH, which is a white hard wheat, was used for the material wheat.

### Comparative Examples 4 to 10

A wheat bran composition was obtained by performing a wet-heat treatment as in Example 1, except that, for the material wheat, either a domestic wheat (type: Kitahonami; Comparative Examples 4 and 5) which is a red medium-hard wheat, No. 1 Canada Western Red Spring (1CW; produced in Canada; Comparative Examples 6 to 8) which is a red hard wheat, or Dark Northern Spring (DNS; produced in the U.S.A.; Comparative Examples 9 and 10) which is a red hard wheat was used.

Evaluation 1: Bread Production

A dough was prepared by mixing the respective wheat bran composition of one of the Examples and Comparative Examples and the following ingredients according to the following proportions, and bread was produced as a secondary processed product (processed food) through the following bread production steps. Ten expert panelists produced and ate the bread to evaluate the processability (secondary processability) of the dough during bread production and the flavor and texture of the obtained bread. In the evaluation of the Examples and Comparative Examples by the panelists, the respective evaluation was conducted according to the following evaluation criteria, with the wheat bran composition of Comparative Example 4 being employed as a control example and the evaluation score for when bread was produced using the control example, as well as the evaluation score for when this bread was eaten, being set to 2. The results are shown in Table 1 as arithmetic mean values.

Bread Ingredients (unit of each ingredient below: parts by mass):

Wheat flour (hard wheat flour): 60

Wheat bran composition: 30

Gluten: 10

Wheat germ: 0.5

Fermenting species: 5

Dough improving agent: 0.8

Fresh yeast: 3.5

Table salt: 2

Refined sugar: 4

Skimmed milk powder: 2

Shortening: 6

Water: 74

(Gluten: H-10 from Ogawa Seifun. Wheat germ: Higy SP from Fresh Food Service Co., Ltd. Fermenting species: Crème de Levain from Oriental Yeast Co., Ltd. Dough improving agent: Euro-Bake Sirius from Oriental Yeast Co., Ltd.)

Bread Production Steps:

The ingredients were placed in a mixing device (Vertical Mixer HPi-20M from Kanto Kongoki Industrial Co., Ltd.) and were mixed in the following order at a product temperature of 27° C. for 7 minutes at low speed, then for 5 minutes at mid-low speed, and then for 2 minutes at mid-high speed, to prepare a mixture (dough). The dough was left to stand and fermented under conditions of 27° C., 75% RH for 60 minutes. The fermented dough was divided into 450-g pieces, and the pieces were left to stand for a bench time of 20 minutes. These pieces of dough were shaped into rolls, and each roll was placed in a one-loaf-type bread loaf pan and left to stand for final proof under conditions of 38° C., 85% RH for 50 minutes. Finally, the dough subjected to final proofing was baked at 220° C. for 30 minutes, to obtain bread loafs containing the respective wheat bran composition of the Examples and Comparative Examples.

Evaluation of Secondary Processability of Bread:

5: The dough came together significantly more easily than the control example (Comparative Example 4) and had very good secondary processability.

4: The dough came together more easily than the control example and had good secondary processability.

3: The dough came together somewhat more easily than the control example and had somewhat good secondary processability.

2: The dough had a secondary processability comparable to that of the control example.

1: The dough did not come together easily compared to the control example and had poor secondary processability.

Texture of Bread:

5: Significantly softer than the control example (Comparative Example 4) and had very good texture.

4: Softer than the control example and had good texture.

3: Somewhat softer than the control example and had somewhat good texture.

2: Texture was comparable to that of the control example.

1: Harder than the control example and had poor texture.

Flavor of Bread:

5: Very good flavor, with no or very little acridness compared to the control example (Comparative Example 4).

4: Good flavor, with less acridness than the control example.

3: Somewhat good flavor, with somewhat less acridness than the control example.

2: Flavor was comparable to that of the control example.

1: Poor flavor, with stronger acridness than the control example.

Evaluation 2: Noodle Production

A dough was prepared by mixing the respective wheat bran composition of one of the Examples and Comparative Examples and the following ingredients according to the following proportions, and noodles were produced as a secondary processed product (processed food) through the following noodle production steps. Ten expert panelists produced and ate the noodles to evaluate the processability (secondary processability) of the dough during noodle production and the flavor and texture of the obtained noodles. In the evaluation of the Examples and Comparative Examples by the panelists, the respective evaluation was conducted according to the following evaluation criteria, with the wheat bran composition of Comparative Example 4 being employed as a control example and the evaluation score for when noodles were produced using the control example, as well as the evaluation score for when the noodles were eaten, being set to 2. The results are shown in Table 1 as arithmetic mean values.

Noodle Ingredients (unit of each ingredient below: parts by mass):

Premix Powder:

Wheat flour (medium-strength wheat flour): 52

Wheat bran composition: 30

Gluten: 14

Dried egg white: 3

Thickener: 1

Liquid for Dough Preparation:

Table salt: 1

Kansui (alkaline solution): 1.5

Water: 58

(Gluten: H-10 from Ogawa Seifun. Dried egg white: Sunkirara RS from Taiyo Kagaku Co., Ltd. Thickener: Neosoft T from Taiyo Kagaku Co., Ltd.)

Noodle Production Steps:

The premix powder and the liquid for dough preparation were placed in a mixer device for noodle production and were mixed in the following order under vacuum conditions (700 mmHg) for 5 minutes at high speed and then for 7 minutes at low speed, to prepare a mixture (dough). The obtained noodle dough was rolled and combined into a 1.6-mm-thick ribbon, and was then cut into strands with a #20 square-blade slitter. The strands were boiled and cooked in boiling water, to obtain noodles containing the respective wheat bran composition of the Examples and Comparative Examples.

Evaluation of Secondary Processability of Noodles:

5: The dough came together significantly more easily than the control example (Comparative Example 4) and had very good secondary processability.

4: The dough came together more easily than the control example and had good secondary processability.

3: The dough came together somewhat more easily than the control example and had somewhat good secondary processability.

2: The dough had a secondary processability comparable to that of the control example.

1: The dough did not come together easily compared to the control example and had poor secondary processability.

Texture of Noodles:

5: Very good texture, with higher resilience and chewiness than the control example (Comparative Example 4).

4: Good texture, with higher resilience and chewiness than the control example.

3: Somewhat good texture, with somewhat higher resilience and chewiness than the control example.

2: Texture was comparable to that of the control example.

1: Poor texture, with less resilience and chewiness than the control example.

Flavor of Noodles:

5: Very good flavor, with no or very little acridness compared to the control example (Comparative Example 4).

4: Good flavor, with less acridness than the control example.

3: Somewhat good flavor, with somewhat less acridness than the control example.

2: Flavor was comparable to that of the control example.

1: Poor flavor, with stronger acridness than the control example.

TABLE 1

| | | Compara- | | | | | | Compara- | | | |
|---|---|---|---|---|---|---|---|---|---|---|---|
| | | tive Ex- | Exam- | Exam- | Exam- | Exam- | Exam- | tive Ex- | Exam- | Exam- | Exam- |
| | | ample 1 | ple 1 | ple 2 | ple 3 | ple 4 | ple 5 | ample 2 | ple 6 | ple 7 | ple 8 |
| Wheat bran | Type of wheat (color; | ASW (white; medium-hard) | | | | | | WW (white; soft) | | | |
| composition | hardness) | | | | | | | | | | |
| | Dietary fiber (mass %) | 39.2 | 43.3 | 45.4 | 48.5 | 49.6 | 48.3 | 39.4 | 45.8 | 47.2 | 47.1 |
| | Glucide (mass %) | 24.3 | 18.0 | 17.7 | 16.7 | 12.2 | 16.8 | 22.6 | 16.9 | 16.3 | 16.0 |
| | Arabinoxylan (mass %) | 17.6 | 20.1 | 20.7 | 22.0 | 21.9 | 21.6 | 17.7 | 20.9 | 21.5 | 21.3 |
| | Alkylresorcinol (mass %) | 0.24 | 0.25 | 0.29 | 0.33 | 0.35 | 0.31 | 0.24 | 0.27 | 0.32 | 0.32 |
| | Heat treatment | Wet- | Wet- | Wet- | Wet- | Wet- | Dry- | Wet- | Wet- | Wet- | Dry- |
| | | heat | heat | heat | heat | heat | heat | heat | heat | heat | heat |
| Bread | Secondary processability | 2.3 | 3.8 | 4.5 | 4.8 | 5.0 | 4.3 | 1.8 | 3.3 | 3.5 | 3.2 |
| production | Flavor | 3.5 | 3.8 | 4.7 | 4.9 | 4.9 | 3.8 | 3.2 | 3.9 | 3.8 | 3.1 |
| evaluation | Texture | 2.4 | 3.7 | 4.4 | 4.6 | 4.8 | 4.4 | 1.7 | 3.4 | 3.6 | 3.3 |
| Noodle | Secondary processability | 2.4 | 3.7 | 4.6 | 4.8 | 4.9 | 4.3 | 2.3 | 3.6 | 3.6 | 3.2 |
| production | Flavor | 3.6 | 4.0 | 4.7 | 4.7 | 4.9 | 3.8 | 3.3 | 4.0 | 4.1 | 3.2 |
| evaluation | Texture | 2.6 | 3.8 | 4.4 | 4.5 | 4.9 | 4.0 | 2.0 | 3.4 | 3.8 | 3.1 |

| | | Com- | | | | Com- | Com- | Com- | Com- | Com- | Com- | Com- |
|---|---|---|---|---|---|---|---|---|---|---|---|---|
| | | para- | | | | para- | para- | para- | para- | para- | para- | para- |
| | | tive | | | | tive | tive | tive | tive | tive | tive | tive |
| | | Exam- | Exam- | Exam- | Exam- | Exam- | Exam- | Exam- | Exam- | Exam- | Exam- | Exam- |
| | | ple 3 | ple 9 | ple 10 | ple 11 | ple 4 | ple 5 | ple 6 | ple 7 | ple 8 | ple 9 | ple 10 |
| Wheat bran | Type of wheat (color; | PH (white; hard) | | | | Domestic wheat (red; | | ICW (red; hard) | | | DNS (red; hard) | |
| composition | hardness) | | | | | medium-hard) | | | | | | |
| | Dietary fiber (mass %) | 38.6 | 45.3 | 46.9 | 46.7 | 41.3 | 45.6 | 40.2 | 46.7 | 48.3 | 36.2 | 45.8 |
| | Glucide (mass %) | 22.6 | 17.8 | 16.9 | 17.0 | 20.3 | 17.6 | 21.3 | 17.1 | 15.6 | 28.4 | 16.9 |
| | Arabinoxylan (mass %) | 17.4 | 20.4 | 20.8 | 20.9 | 18.6 | 20.8 | 18.1 | 21.8 | 22.2 | 16.3 | 21.0 |
| | Alkylresorcinol (mass %) | 0.24 | 0.26 | 0.28 | 0.30 | 0.24 | 0.30 | 0.22 | 0.32 | 0.33 | 0.22 | 0.26 |
| | Heat treatment | Wet- | Wet- | Wet- | Dry- | Wet- | Wet- | Wet- | Wet- | Wet- | Wet- | Wet- |
| | | heat | heat | heat | heat | heat | heat | heat | heat | heat | heat | heat |
| Bread | Secondary processability | 2.1 | 3.6 | 3.8 | 3.3 | 2.0 | 2.6 | 1.4 | 2.3 | 2.4 | 1.5 | 2.4 |
| production | Flavor | 3.4 | 4.3 | 4.4 | 3.6 | 2.0 | 2.2 | 1.2 | 1.4 | 1.4 | 1.3 | 1.4 |
| evaluation | Texture | 2.2 | 3.8 | 3.8 | 3.4 | 2.0 | 2.5 | 1.6 | 2.2 | 2.5 | 1.4 | 2.3 |
| Noodle | Secondary processability | 2.2 | 3.9 | 4.0 | 3.3 | 2.0 | 2.3 | 1.2 | 1.9 | 2.1 | 1.3 | 1.8 |
| production | Flavor | 3.4 | 4.3 | 4.3 | 3.4 | 2.0 | 2.3 | 1.2 | 1.2 | 1.4 | 1.1 | 1.1 |
| evaluation | Texture | 2.1 | 3.9 | 4.0 | 3.5 | 2.0 | 2.2 | 1.3 | 1.9 | 2.0 | 1.1 | 1.9 |

Table 1 shows that, by using the wheat bran compositions that contain a white wheat as a raw material and have a dietary fiber content and a glucide content within a predetermined range, it is possible to achieve excellent secondary processability and to produce processed foods having excellent appearance, flavor and texture. Particularly, Examples 1 to 4 show that, by using the wheat bran compositions that contain a white medium-hard wheat as a raw material, have a dietary fiber content and a glucide content within a preferable range, and have been subjected to a wet-heat treatment, it is possible to achieve excellent secondary processability and to produce processed foods having even better appearance, flavor and texture.

### INDUSTRIAL APPLICABILITY

The present invention provides a wheat bran composition that has excellent secondary processing suitability and that can be processed into secondary processed products having excellent appearance, flavor and texture, and also a method for producing the wheat bran composition.

1. A wheat bran composition comprising a white wheat as a raw material, wherein the wheat bran composition has a dietary fiber content of 43 mass % or greater and a glucide content of 18 mass % or less.

2. The wheat bran composition according to claim 1, wherein the white wheat is a medium-hard wheat.

3. The wheat bran composition according to claim 1, wherein the wheat bran composition has an average particle size of 200 μm or less.

4. The wheat bran composition according to claim 1, wherein the wheat bran composition is subjected to a heat treatment.

5. The wheat bran composition according to claim 1, wherein the wheat bran composition is subjected to a wet-heat treatment.

6. The wheat bran composition according to claim 1, wherein the wheat bran composition has an arabinoxylan content of 20 mass % or greater.

7. The wheat bran composition according to claim 1, wherein the wheat bran composition has an alkylresorcinol content of 0.25 mass % or greater.

8. A method for producing a wheat bran composition, comprising pulverizing grains of a white wheat to obtain a wheat bran composition having a dietary fiber content of 43 mass % or greater and a glucide content of 18 mass % or less.

9. A premix comprising the wheat bran composition according to claim 1.

10. A method for producing a processed food comprising using, as a raw material, the wheat bran composition according to claim 1.
